(19) United States
(12) Patent Application Publication
(10) Pub. No.: US 2025/0244755 A1
(43) Pub. Date: Jul. 31, 2025

(54) EARLY MEMORY ACCESS FOR LONG DURATION MEMORY MODIFICATION OPERATIONS AND MANUFACTURING PROCESS OF A COMPONENT THEREFOR

(71) Applicant: Next Silicon Ltd, Givatayim (IL)

(72) Inventors: Alexander MARGOLIN, Ashdod (IL); Ilan TAYARI, Tzur Hadassa (IL); Tal SEGAL, Jerusalem (IL); Elad RAZ, Ramat Gan (IL)

(73) Assignee: Next Silicon Ltd, Givatayim (IL)

(21) Appl. No.: 18/427,947

(22) Filed: Jan. 31, 2024

(51) Int. Cl. G05B 19/418

(52) U.S. Cl. CPC G05B 19/4188; G05B 2219/13158; G05B 2219/45031

(57) ABSTRACT

A system for accessing memory comprising a memory management component configured to: mark each of a plurality of memory areas as pending in response to identifying at least one data retrieval instruction directed towards a target memory comprising the plurality of memory areas, each memory area associated with a range of memory addresses that is mapped thereto; and while at least one of the plurality of memory areas is marked as pending: remove the marking as pending for at least one first memory area of the plurality of memory areas upon the at least one first memory area being ready for access; and access at least one first value in the at least one first memory area in response to at least one first memory access instruction, subject to the removal of the marking as pending of the at least one first memory area; and a manufacturing processes thereof.

### BACKGROUND

Some embodiments described in the present disclosure relate to a computerized system and, more specifically, but not exclusively, to a system executing a plurality of threads.

As used herewithin, the term “data retrieval” is used to mean one or more computer instructions that store data values in a computer memory. Some examples include reading the data values from other computer memory or from non-volatile storage. Another example of data retrieval is transferring data from a digital communication network interface into the computer memory. Another example is a computation that produces an outcome that is stored in the computer memory.

For brevity, unless otherwise indicated, herewithin the term “instruction” is used to mean “computer instruction” and the terms are used interchangeably.

It is common practice in computer programming to execute one or more computer instructions to retrieve data into computer memory, and execute one or more other computer instructions that access the data that was retrieved into the computer memory. Correct operation of a computer system frequently depends on assuring data integrity such that the one or more other computer instructions access the computer memory only after the retrieved data has been stored therein.

Thanks to advancements in hardware, storage technologies and data access methods, data retrieval has become faster over the years. However, despite these improvements, data retrieval can still be slow compared to processing speeds, leading to delays in access to the retrieved data and as a result overall reduction in a system's performance, for example when measured in the amount of time to perform an operation (latency) and additionally or alternatively an amount of operations performed in a given amount of time (throughput).

### SUMMARY

It is an object of some embodiments described in the present disclosure to provide a system and a method for accessing target memory while the target memory is being modified by a long duration memory modification operation, before completion of the long duration memory modification operations. In some such embodiments, when the target memory comprises a plurality of memory areas, in response to identifying a memory modification operation directed towards the target memory, each of the plurality of memory areas of the target memory is marked as pending. Further in such embodiments, while one or more of the plurality of memory areas is still marked as pending, upon at least one first memory area being ready for access the marking as pending is removed therefor, allowing access to one or more values in the at least one first memory area while other memory areas towards which the memory modification operation is directed are not ready for access. Removing the marking as pending of a first memory area of the plurality of memory areas while other of the plurality of memory areas remain marked as pending allows accessing available data in the target memory before completion of the memory modification operation while at the same time preventing access to other memory areas in the target memory where data is not yet available. This reduces latency of executing an instruction to access the one or more values compared to waiting until the memory modification operation completes and the entire target memory is ready for access, as well as reduces latency in executing other instructions that follow the instruction to access the one or more values, while at the same time preserving data integrity. Using a marking that indicates whether a memory area is ready is more efficient than repeatedly reading the content of the memory area to determine whether data is available and ready for access as accessing the marking does not increase the load on data paths that access the memory area and thus does not impact other memory access operations.

The foregoing and other objects are achieved by the features of the independent claims. Further implementation forms are apparent from the dependent claims, the description and the figures.

According to a first aspect, a system for accessing memory comprises at least one memory management component configured to: mark each of a plurality of memory areas as pending in response to identifying at least one data retrieval instruction directed towards a target memory comprising the plurality of memory areas, each memory area associated with a range of memory addresses that is mapped thereto; and while at least one of the plurality of memory areas is marked as pending: remove the marking as pending for at least one first memory area of the plurality of memory areas upon the at least one first memory area being ready for access; and access at least one first value in the at least one first memory area in response to at least one first memory access instruction, subject to the removal of the marking as pending of the at least one first memory area.

According to a second aspect, a method of accessing memory, comprises: marking each of a plurality of memory areas as pending in response to identifying at least one data retrieval instruction directed towards a target memory comprising the plurality of memory areas, each memory area associated with a range of memory addresses that is mapped thereto; and while at least one of the plurality of memory areas is marked as pending: removing the marking as pending for at least one first memory area of the plurality of memory areas upon the at least one first memory area being ready for access; and accessing at least one first value in the at least one first memory area in response to at least one first memory access instruction, subject to the removal of the marking as pending of the at least one first memory area.

According to a third aspect, a software program product for accessing memory, comprises: a non-transitory computer readable storage medium; first program instructions for marking each of a plurality of memory areas as pending in response to identifying at least one data retrieval instruction directed towards a target memory comprising the plurality of memory areas, each memory area associated with a range of memory addresses that is mapped thereto; and second program instructions for while at least one of the plurality of memory areas is marked as pending: removing the marking as pending for at least one first memory area of the plurality of memory areas upon the at least one first memory area being ready for access; and accessing at least one first value in the at least one first memory area in response to at least one first memory access instruction, subject to the removal of the marking as pending of the at least one first memory area; wherein the first and second program instructions are executed by at least one computerized processor from the non-transitory computer readable storage medium.

According to a fourth aspect, a method for producing a memory management component comprises: forming a substrate; depositing a plurality of logical elements on the substrate; and incorporating a plurality of interconnects to establish at least one communication pathway among the plurality of logical elements such that the memory management component is configured to: mark each of a plurality of memory areas as pending in response to identifying at least one data retrieval instruction directed towards a target memory comprising the plurality of memory areas, each memory area associated with a range of memory addresses that is mapped thereto; and while at least one of the plurality of memory areas is marked as pending: remove the marking as pending for at least one first memory area of the plurality of memory areas upon the at least one first memory area being ready for access; and access at least one first value in the at least one first memory area in response to at least one first memory access instruction, subject to the removal of the marking as pending of the at least one first memory area.

With reference to the first and second aspects, in a first possible implementation of the first and second aspects the at least one memory management component comprises at least one memory management circuitry configured to execute one or more of: mark each of the plurality of memory areas as pending, remove the mark as pending, and access the at least one first value. Implementing at least some of the steps described above in hardware allows reducing time of execution of said steps, and additionally or alternatively reducing latency in execution of said steps. In addition, implementing at least some of the steps in hardware reduces an impact, for example in terms of latency and/or throughput, that management of access to the plurality of memory areas with relation to execution of the at least one data retrieval instruction may have on executing other computer instructions.

With reference to the first and second aspects, in a second possible implementation of the first and second aspects the at least one memory management component comprises at least one hardware processor configured to execute a code to execute one or more of: mark each of the plurality of memory areas as pending, remove the mark as pending, and access the at least one first value. Implementing at least some of the steps described above using a hardware processor may reduce cost of development of a system implementing some methods described in the present disclosure.

With reference to the first and second aspects, in a third possible implementation of the first and second aspects the at least one memory management component comprises for each of the plurality of memory areas a pending indicator associated therewith, for marking whether the memory area associated with the pending indicator is pending. Implementing a pending indicator in the one or more memory management components reduces latency in accessing and modifying the pending indicator compared to accessing another component.

With reference to the first and second aspects, in a fourth possible implementation of the first and second aspects the at least one memory management component is further configured to: compute a first identification of the at least one data retrieval instruction; and in response to the first identification of the at least one data retrieval instruction, compute a second identification of the plurality of memory areas to mark as pending. Identifying the one or more data retrieval instructions and the plurality of memory areas using hardware circuitry reduces an amount of time to compute the first and second identifications and reduces latency in computing the first and second identifications, increasing accuracy of marking whether a memory area is pending or ready.

With reference to the first and second aspects, in a fifth possible implementation of the first and second aspects the at least one memory management component is further configured to: identify that the at least one first memory area is ready for access; and remove the marking as pending for the at least one first memory area. Optionally, the at least one memory management component is configured to identify that the at least one first memory area is ready for access when one or more data values are stored in the at least one first memory area as an outcome of executing the at one data retrieval instruction. Optionally, an amount of data values in the one or more data values exceeds an identified threshold value. Optionally, the memory management component is configured to identify that the at least one first memory area is ready for access when executing the at least one data retrieval instruction stores data in all of the at least one first memory area. Identifying that the one or more first memory areas are ready when the one or more data retrieval instructions store in the one or more first memory areas an amount of data increases likelihood of accessing value data when executing the one or more first memory access instructions, independently of validity of data in other memory areas of the plurality of memory areas.

With reference to the first and second aspects, in a sixth possible implementation of the first and second aspects the system further comprises: at least one hardware processor configured to execute at least one software object; and a page table mapping a plurality of application memory addresses to the plurality of memory areas, where an application memory address is a memory address of the at least one software object. Optionally, for each memory area of the plurality of memory areas, the range of memory addresses that is mapped to the memory area is a range of application memory addresses of the at least one software object and marking each of the plurality of memory areas as pending is in the page table. Optionally, the page table comprises a plurality of page table entries, each for mapping at least one range of application memory addresses to at least one of the plurality of memory areas and each of the plurality of page table entries comprises a validity indicator, indicative of whether the page table entry contains a valid mapping. Optionally, marking a memory area is pending is by using a pending indicator that is not a validity indicator. Using a separate indicator to mark a pending area from a validity indicator of a page table allows indicating or preserving a valid memory translation without the actual data being available for access. Optionally, the page table comprises at least one table entry, each mapping a first amount of application memory addresses of the plurality of application memory addresses. Optionally, for at least one memory area of the plurality of memory areas, the range of memory addresses that is mapped to the memory area is a range of application memory addresses of the at least one software object having a second amount of application memory addresses and the first amount of application memory addresses is different from the second amount of application memory addresses. Marking as pending a memory area having an amount of application memory addresses that is different from a page size used by a page table allows controlling which memory area is pending at a finer resolution that a page size, allowing to reduce latency of executing the one or more first memory access instructions.

With reference to the first and second aspects, in a seventh possible implementation of the first and second aspects the at least one memory management component is further configured to: further while the at least one of the plurality of memory areas is marked as pending, decline to access at least one second value in at least one second memory area of the plurality of memory areas, where the at least one second memory area is marked as pending, in response to at least one second memory access instruction. Optionally, the at least one memory management component is further configured to compute a third identification that the at least one second memory area is marked as pending. Optionally, the at least one first memory access instruction comprises a first memory address in a first range of memory addresses mapped to the at least one first memory area; and the at least one second memory access instruction comprises a second memory address in a second range of memory addresses mapped to the at least one second memory area. Optionally, the system further comprises at least one hardware processor configured to execute at least one software object, comprising a plurality of threads; Optionally, the at least one first memory access instruction is executed by at least one first thread of the plurality of threads, and the at least one second memory access instruction is executed by at least one second thread of the plurality of threads. Optionally, the at least one memory management component is further configured to: allow execution of the at least one first thread; and subject to declining to access the at least one second value in the at least memory area that is marked as pending, suspend execution of the at least one second thread. Optionally, the at least one memory management component is further configured to: remove the marking as pending for the at least one second memory area upon the at least one second memory area being ready for access; and resume execution of the at least one second thread subject to removing the marking as pending for the at least one second memory area. Optionally, the at least one second memory access instruction comprises at least one application memory address of the at least one software object. Optionally, suspending execution of the at least one second thread comprises creating a mapping between the at least one application memory address and the at least one second thread. Optionally, the at least one memory management component is further configured to: subject to removing the marking as pending for the at least one second memory area, resume the at least one second thread according to the mapping. Creating a mapping between the one or more application memory addresses that were not ready for access and the one or more second threads allows quick and simple identification of the threads pending access to the one or more second memory areas, reducing latency in resuming the pending threads when the one or more second memory areas become ready compared to using a timeout.

With reference to the first and second aspects, or the seventh implementation of the first and second aspects, in an eighth possible implementation of the first and second aspects the system further comprises at least one reconfigurable processing grid connected to the at least one hardware processor. Optionally, the at least one reconfigurable processing grid is configured to execute at least one of the at least one first thread and the at least one second thread. Optionally, the at least one reconfigurable processing grid comprises one or more of the at least one memory management component.

With reference to the first and second aspects, in a ninth possible implementation of the first and second aspects the system further comprises at least one non-volatile digital storage. Optionally, the at least one data retrieval instruction comprises an instruction to read from a file stored on the non-volatile digital storage. Optionally, the system further comprises at least one hardware processor. Optionally, the at least one data retrieval instruction comprises at least one of: an instruction to receive data via at least one digital communication network interface connected to the at least one hardware processor; and an instruction to receive data from at least one software process executed by the at least one hardware processor.

With reference to the first and second aspects, in a tenth possible implementation of the first and second aspects marking a memory area as pending is by using a non-Boolean value. Using a non-Boolean value allows using more than two states to describe the status of a memory area, increasing accuracy of access to the memory area and management of one or more threads requesting access to the memory area (for example, suspending execution of a thread for an amount of time that is dependent on a non-Boolean value of marking the memory area as pending).

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Unless otherwise defined, all technical and/or scientific terms used herein have the same meaning as commonly understood by one of ordinary skill in the art to which embodiments pertain. Although methods and materials similar or equivalent to those described herein can be used in the practice or testing of embodiments, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments are herein described, by way of example only, with reference to the accompanying drawings. With specific reference now to the drawings in detail, it is stressed that the particulars shown are by way of example and for purposes of illustrative discussion of embodiments. In this regard, the description taken with the drawings makes apparent to those skilled in the art how embodiments may be practiced.

### In the Drawings:

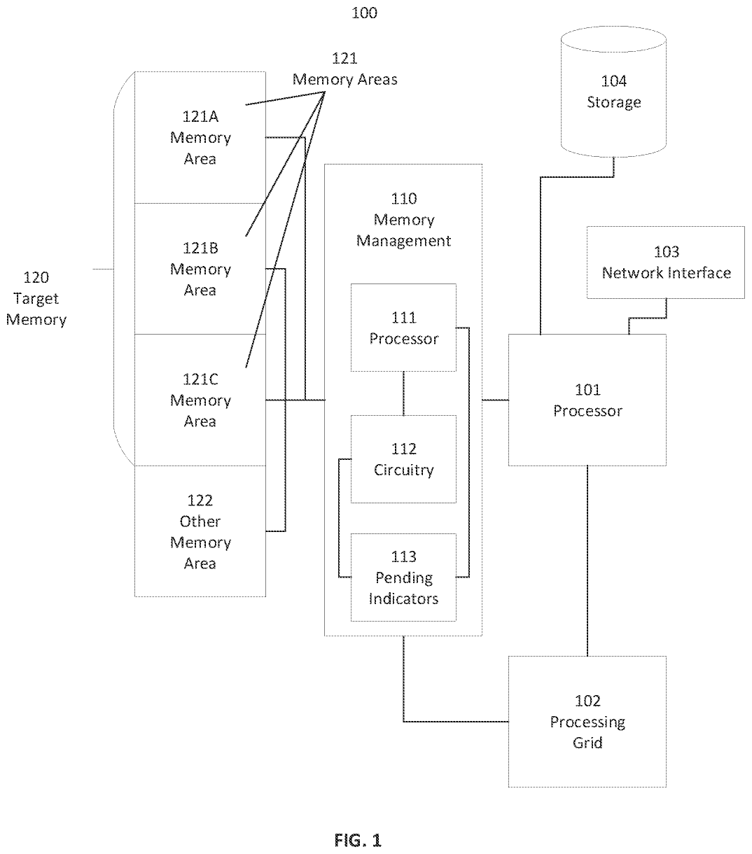

FIG. 1 is a schematic block diagram of an exemplary system, according to some embodiments;

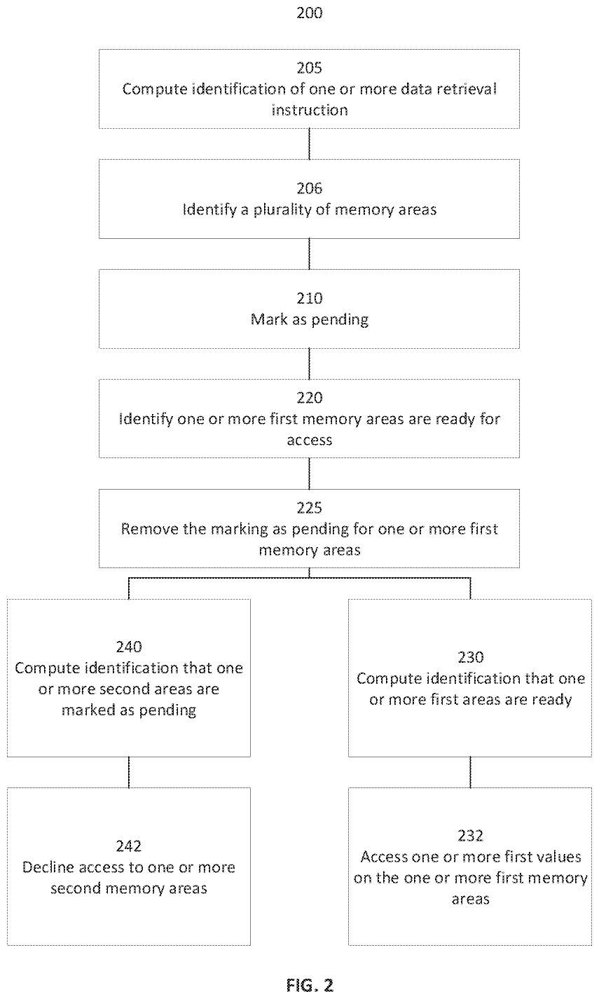

FIG. 2 is a flowchart schematically representing an optional flow of operations, according to some embodiments;

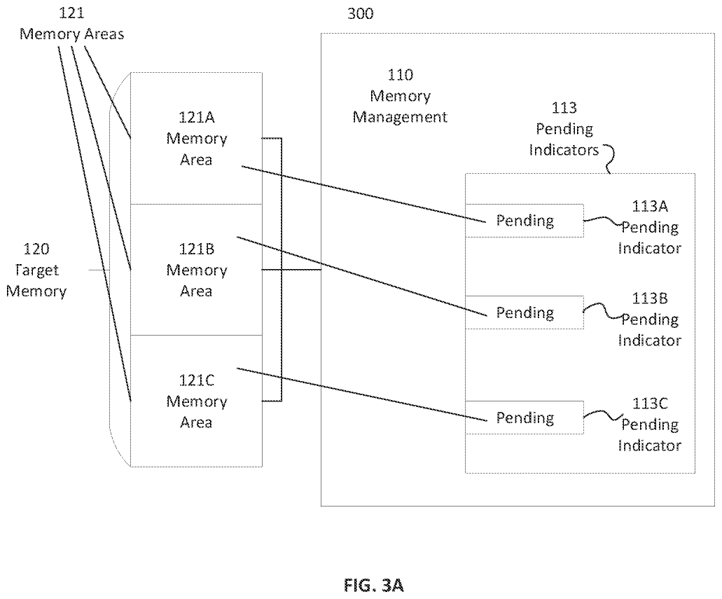

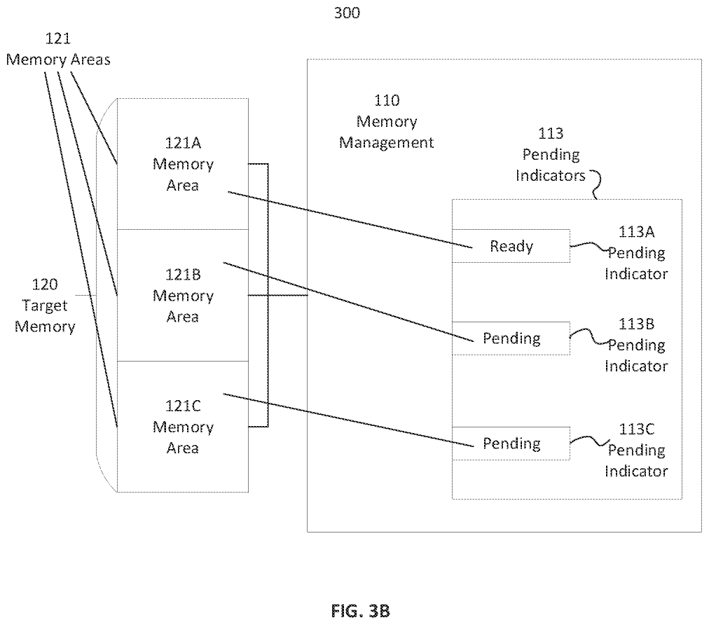

FIGS. 3A and 3B are schematic block diagrams of an exemplary sub-system, according to some embodiments;

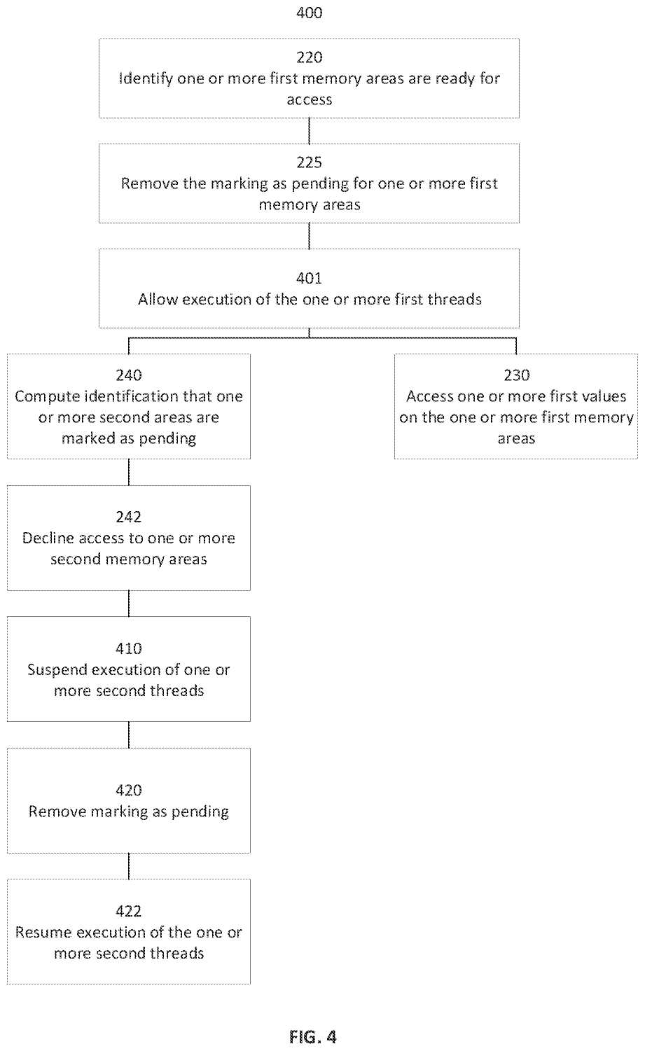

FIG. 4 is a flowchart schematically representing an optional flow of operations for executing a plurality of threads, according to some embodiments;

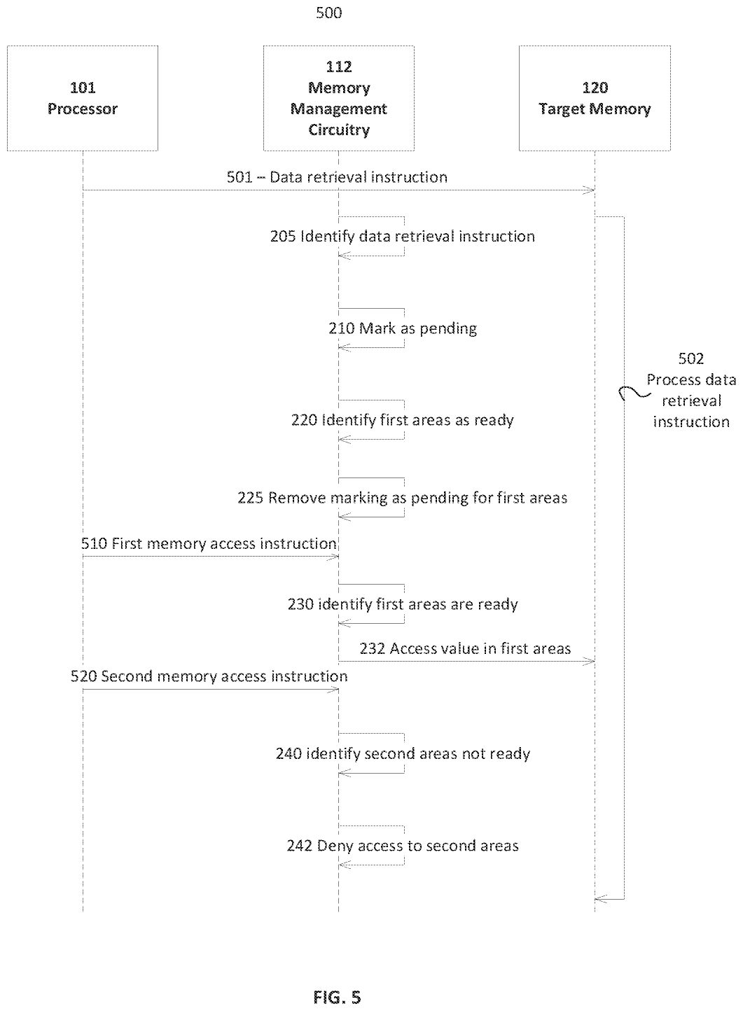

FIG. 5 is a sequence diagram of an optional flow of operations for a memory management component comprising memory management circuitry, according to some embodiments;

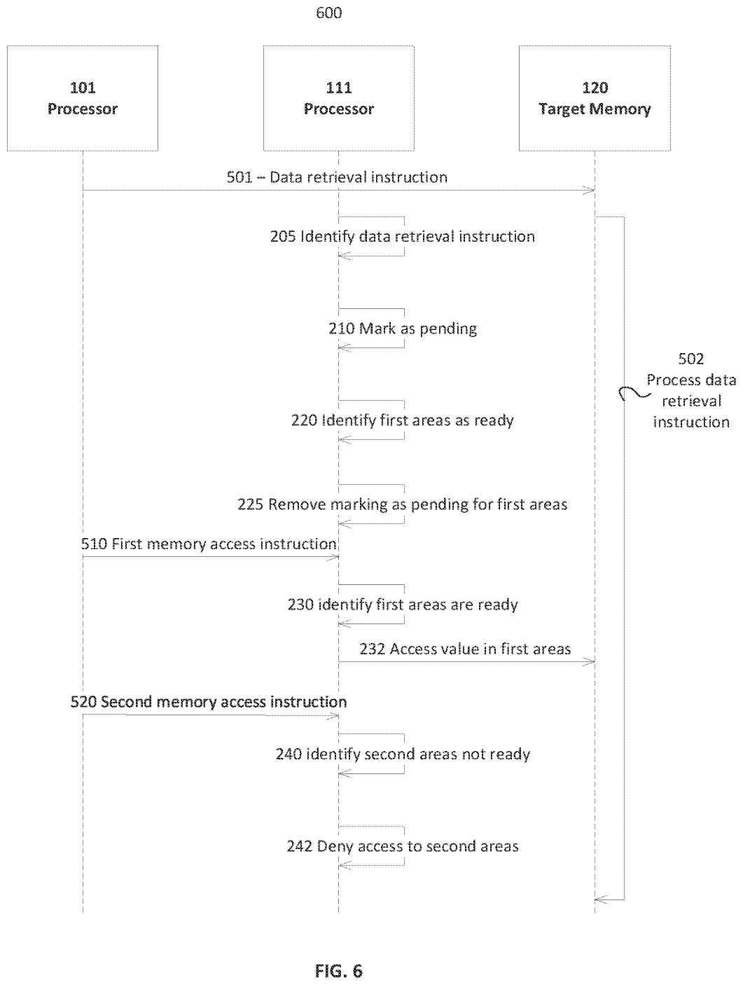

FIG. 6 is a sequence diagram of an optional flow of operations for a memory management component comprising one or more hardware processors, according to some embodiments;

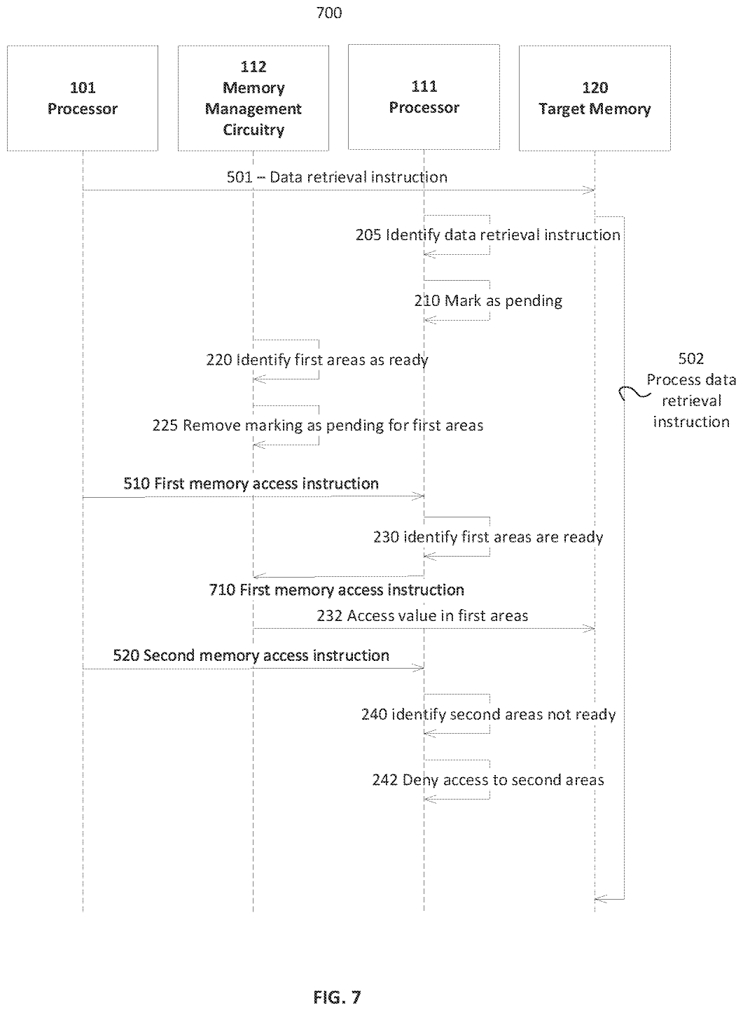

FIG. 7 is a sequence diagram of an optional flow of operations for a memory management component comprising memory management circuitry and one or more hardware processors, according to some embodiments;

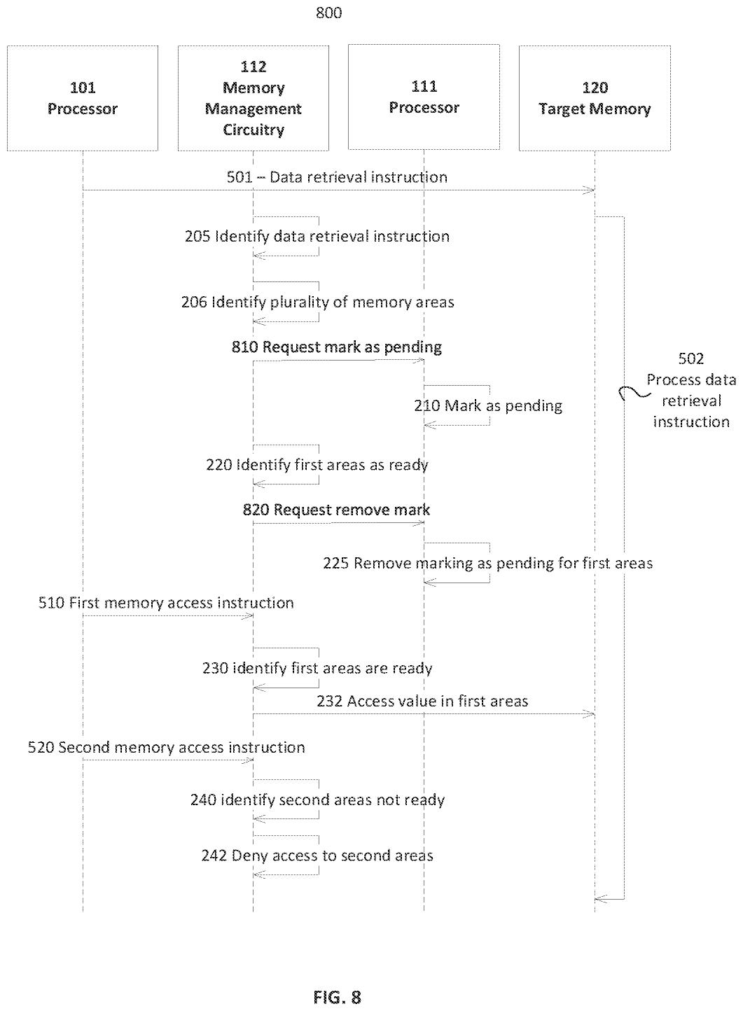

FIG. 8 is a sequence diagram of another optional flow of operations for a memory management component comprising memory management circuitry and one or more hardware processors, according to some embodiments; and

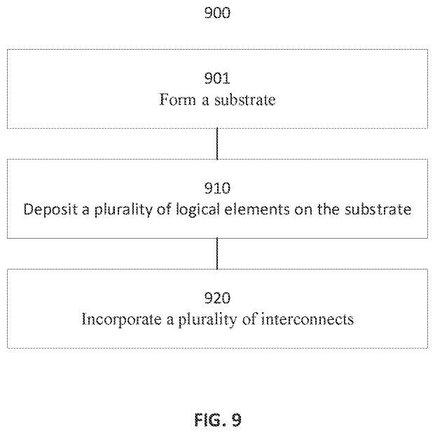

FIG. 9 is a flowchart schematically representing an optional flow of operations for producing a memory management component, according to some embodiments.

### DETAILED DESCRIPTION

Preventing access to computer memory that is being modified is essential to ensure data integrity and prevent potential issues like race conditions, data corruption, and unintended side effects in software applications. In multi-threaded or multi-process environments where multiple entities might attempt to access and modify the same memory simultaneously there are a variety of methods to ensure data integrity. Some common methods to protect data integrity enforce mutual exclusion using a locking mechanism that controls access to a memory area. Other methods to protect data integrity use transactional memory, allowing a block of code to be executed atomically, as if it were a single operation, and rolling back changes when a conflict with another transaction is detected. In digital communication networking there exist methods for processing the header of a network packet before the entire packet is transferred from the network to computer memory.

However, in such existing methods, the protection is applied to the entire target memory of a memory modification operation as one protected unit. Thus, when a memory modification operation is executing, the entire target memory of the memory modification operation must be ready before one or more other instructions can access any part of the target memory. This is also correct for some methods for processing network packets, where while the header of a network packet may be processed before the entire network packet is transferred to computer memory, such methods do not provide access to the packet's payload of data before all the payload data is transferred to computer memory.

As a result, even when some data in a target memory towards which a memory modification operation is directed is available, access to any part of the target memory is delayed until execution of the memory modification operation is complete. This pertains not only to multi-threaded or multi-process environments. A thread that issues a memory modification operation, comprising one or more data retrieval instructions, cannot access any part of the target memory of the memory modification operation until the one or more data retrieval instructions have completed executing.

There is a need to allow, in a computerized system, access to one or more parts of the target memory of a memory modification operation before execution of the memory modification operation is complete, to reduce latency of performing a task and additionally or alternatively increase an amount of tasks performed in an identified amount of time.

To do so, in some embodiments described herewithin, the present disclosure proposes managing access to each of a plurality of memory areas of the target memory independently from each other. In such embodiments, the present disclosure proposes identifying one or more data retrieval instructions directed towards a target memory comprising a plurality of memory areas and marking each of the plurality of memory areas as pending in response to identifying the one or more data retrieval instructions. Optionally, when one or more first memory areas of the plurality of memory areas are ready for access, the present disclosure proposes removing the marking as pending for the one or more first memory areas, while one or more of the plurality of memory areas is marked as pending. It should be noted that the one or more first memory areas are not members of the one or more memory areas that are marked as pending, i.e. when removing the marking as pending for the one or more first memory areas the marking as pending of the one or more memory areas is not removed. Optionally, while the one or more memory areas are marked as pending, the present disclosure proposes accessing one or more data values in the one or more first memory areas, subject to the removal of the marking as pending for the one or more first memory areas. In such embodiments, the one or more memory areas are marked as pending as execution of the one or more data retrieval instructions has not completed, i.e. the marking as pending is removed for the one or more first memory areas during execution of the one or more data retrieval instructions, before execution of the one or more data retrieval instructions completes. Optionally, the one or more data values in the one or more first memory areas are accessed before execution of the one or more data retrieval instructions completes, reducing an amount of time between a first time where the one or more data values became available and a second time where the one or more data values were accessed compared to waiting until execution of the one or more data retrieval instructions has completed. This reduction of time facilitates improving overall performance of a system implemented according to some embodiments described in the present disclosure, for example reducing latency and additionally or alternatively increasing throughput.

Optionally, the one or more memory management components comprise a pending indicator for each of the plurality of memory areas. Optionally, the pending indicator is a Boolean value. Optionally, the pending indicator is a non-Boolean value, for example a value indicative of an amount of valid values in the memory area or a data structure that contains information about expected resume times of one or more suspended threads that have one or more instructions to access the memory area.

Optionally, the one or more memory management components are configured to identify the one or more data retrieval instructions. Optionally, the one or more memory management components are configured to identify when one or more of the plurality of memory areas are ready for access. Optionally, a memory area is ready for access when one or more data values are stored in the memory area as an outcome of executing the one or more data retrieval instructions. Optionally, the memory area is ready for access when sufficient data values are stored therein, i.e. an amount of data values stored in the memory area as an outcome of executing the one or more data retrieval instructions exceeds an identified threshold value. Optionally, the memory area is ready for access when it is completely written by executing the one or more data retrieval instructions, i.e. when executing the one or more data retrieval instructions stores data in all of the memory area.

Optionally, a system comprises one or more memory management components for marking each of the plurality of memory areas as pending, for removing the marking as pending and for accessing the one or more values. The steps described above and other steps executed by the one or more memory management components may be implemented in any combination of hardware and software. Optionally, the one or more memory management components comprise at least one memory management circuitry. Optionally, the one or more memory management components comprise one or more hardware processors configured to execute a code.

Optionally, marking each of the plurality of memory areas as pending is in a page table of the computerized system, where the page table maps a plurality of application memory addresses to the plurality of memory areas. Optionally an application memory address is a memory address of one or more software objects executed by one or more hardware processors of the computerized system. It should be noted that managing the pending memory areas may be independent of managing pages of application memory. Thus, while each of a plurality of page table entries of the page table may map a first amount of memory addresses (a page size), at least one of the plurality of memory areas may have a second amount of memory addresses mapped thereto, for example an integer multiple of the page size. Optionally, the page size is an integer multiple of the second amount of memory addresses. It is common for a page table entry to include a validity indicator, indicating whether the page table entry contains a valid address mapping. Optionally, marking in the page table that a memory area as pending is by using a pending indicator in the page table entry that is not a validity indicator. Thus, a page table entry may contain a valid address mapping, however one or more memory areas mapped by the page table entry may be marked as pending in response to executing the one or more data retrieval instructions. In this case, accessing the one or more memory areas mapped by the page table when the one or more memory areas are marked as pending does not cause a page fault. Similarly, an entry in a translation lookaside buffer (TLB) for translating an application memory address mapped to one of the plurality of memory area may be valid while the memory area is marked as pending and the entry is preserved in the TLB even while the memory area is marked as pending.

In addition, in some embodiments described herewithin, the system comprises one or more interconnected computing grids, each comprising a plurality of reconfigurable logical elements connected by a plurality of configurable data routing junctions. Optionally, the one or more interconnected computing grids comprise at least some of the one or more memory management components. Optionally, one or more threads comprising one or more instructions to access at least part of the target memory of the one or more data retrieval instructions are executed by the one or more interconnected computing grids.

Before explaining at least one embodiment in detail, it is to be understood that embodiments are not necessarily limited in its application to the details of construction and the arrangement of the components and/or methods set forth in the following description and/or illustrated in the drawings and/or the Examples. Implementations described herein are capable of other embodiments or of being practiced or carried out in various ways.

Embodiments may be a system, a method, and/or a computer program product. The computer program product may include a computer readable storage medium (or media) having computer readable program instructions thereon for causing a processor to carry out aspects of the embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of embodiments may be assembler instructions, instruction-set-architecture (ISA) instructions, machine instructions, machine dependent instructions, microcode, firmware instructions, state-setting data, or either source code or object code, natively compiled or compiled just-in-time (JIT), written in any combination of one or more programming languages, including an object oriented programming language such as Smalltalk, C++, Java, Object-Oriented Fortran or the like, an interpreted programming language such as JavaScript, Python or the like, and conventional procedural programming languages, such as the “C” programming language, Fortran, or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), a coarse-grained reconfigurable architecture (CGRA), or programmable logic arrays (PLA) may execute the computer readable program instructions by utilizing state information of the computer readable program instructions to personalize the electronic circuitry, in order to perform aspects of embodiments.

Aspects of embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference is now made to FIG. 1, showings a schematic block diagram of an exemplary system 100, according to some embodiments. In such embodiments one or more memory management component 110 are connected to target memory 120. Optionally, target memory 120 is a target memory towards which one or more data retrieval instructions are directed. Optionally, system 100 comprises at least one hardware processor 101, optionally for executing one or more software objects. Optionally, one or more software threads executed by at least one hardware processor 101 execute the one or more data retrieval instructions directed towards target memory 120. Optionally, the at least one hardware processor 101 is connected to the one or more memory management components 110. The at least one hardware processor 101 may be connected directly to the one or more memory management components 110, for example by being electrically coupled to the one or more memory management components 110 or via a bus. Optionally, the at least one hardware processor 101 is connected to the one or more memory management components indirectly, some examples include using one or more of a memory controller component, a cache memory, and a memory interface.

Optionally, the target memory comprises one or more Random Access Memory (RAM) components. Optionally, the target memory comprises one or more High Bandwidth Memory (HBM) components. Other examples of a memory component comprised by the target memory include one or more Read-Only Memory (ROM) components, one or more Non-Volatile Random Access Memory (NVRAM) components, and one or more Erasable Programmable Read-Only Memory (EPROM) components.

Optionally, target memory 120 comprises plurality of memory areas 121, for example comprising memory area 121A, memory area 121B and memory area 121C. Optionally, memory management component 110 is additionally connected to one or more other memory areas 122 that are not members of the plurality of memory areas 121 of the target memory 120. Optionally, each memory area of the plurality of memory areas 121 is associated with one or more ranges of memory addresses. Optionally, for each memory area of the plurality of memory areas, the range or memory addresses associated therewith is mapped thereto. For example, a first range of memory addresses may be mapped to memory area 121A and associated therewith, and a second range of memory addresses may be mapped to memory area 121B and associated therewith. Optionally, a range of memory addresses is a range of application memory addresses of the one or more software objects executed by the at least one hardware processor 101. An application memory address may be a virtual address of the one or more software objects. An application memory address may be a physical memory address of the target memory accessed by the one or more software objects. Other examples of an application memory address is a logical address, a memory interface address and a bus address.

Optionally, the at least one hardware processor 101 is connected to one or more reconfigurable processing grid 102. Optionally, the one or more reconfigurable processing grid 102 comprises a plurality of reconfigurable logical elements, connected by a plurality of reconfigurable data junctions. Optionally, the one or more reconfigurable processing grid 102 is connected to the target memory 120, optionally via memory management 110.

For brevity, henceforth the term processor is used to mean at least one hardware processor, and the terms are used interchangeably. In addition, for brevity henceforth the term grid is used to mean one or more reconfigurable processing grid and the terms are used interchangeably.

Optionally, for example when the grid 102 executes at least part of the one or more software objects, the one or more data retrieval instructions are executed by the one or more reconfigurable processing grid 102. When the one or more software objects comprise a plurality of software threads, the grid 102 optionally executes one or more of the plurality of software threads.

Optionally, the grid 102 comprises at least part of the one or more memory management components 110.

For brevity, unless otherwise specified the term memory management component is used to mean one or more memory management components.

Optionally, the memory management component 110 comprises one or more memory management circuitry 112 (henceforth management circuitry 112, for brevity), configured to manage access to the target memory 120. Optionally, the memory management component 110 comprises one or more memory management hardware processor 111 (henceforth management processor 111, for brevity). The management processor 111 may be a general purpose hardware processor. The management processor 111 may be bespoke processing circuitry. Optionally, the management processor 111 is processor 101. Optionally, the management processor 111 is any other processor of the system 100 (not shown). Optionally, management processor 111 executes a code for managing access to the target memory 120. Optionally, the management processor executes one or more other tasks that are not related to managing access to memory. As described further in this disclosure, access to the target memory 120 may be managed by management circuitry 112, by management processor 111, or any combination thereof.

Optionally, memory management component 110 comprises a plurality of pending indicators 113, comprising a pending indicator for each of the plurality of memory areas 121 and associated therewith, for marking whether the memory area associated with the pending indicator is pending. The plurality of pending indicators 113 may be implemented using software code executed by the management processor 111. The plurality of pending indicators 113 may be implemented using dedicated hardware circuitry. Optionally, the plurality of pending indicators 113 are implemented using one or more other memory areas 122. Optionally, marking whether the memory area associated with a pending indicator is pending is an outcome of a computation and does not include storing a value in a memory location or modifying a hardware circuitry.

Optionally, one or more of the management processor 111, the management circuitry 112 and the plurality of pending indicators are implemented in grid 102.

Optionally, the system 100 comprises a page table mapping a plurality of application memory addresses to the plurality of memory areas 121. Optionally, the page table comprises a plurality of table entries. Optionally each table entry of the plurality of page table entries, maps one or more ranges of application memory addresses to one or more of the plurality of memory areas. Optionally, each of the plurality of page table entries comprises a validity indicator that is indicative of whether the page table entry contains a valid entry.

Optionally, the plurality of pending indicators 113 are implemented in the page table. Optionally, a pending indicator of the plurality of pending indicators 113 is not a validity indicator of a page table entry.

Optionally, an amount of memory addresses mapped by a page table entry of the page table is different from another amount of memory addresses of a range of memory addresses mapped to a memory area of the plurality of memory areas 121. A first range of memory addresses may be mapped to memory area 121A, however a page table entry might map application memory addresses that include both memory area 121A and memory area 121B. In another example, another page table entry might map memory addresses for only part of the memory area 121. A page table entry may map an integer multiple of memory areas of plurality of memory areas 121. A page table entry may map a fraction of a memory area of plurality of memory areas 121.

Optionally, processor 101 is connected to one or more digital communication network interface 103 (henceforth, for brevity, network interface 103). Optionally, network interface 103 is connected to a local area network (LAN), for example an Ethernet network or a Wi-Fi network. Optionally, network interface 103 is connected to a wide area network (WAN), for example a cellular network or the Internet.

Optionally, processor 101 is connected to one or more non-volatile digital storage 104 (henceforth, for brevity, storage 104). Some examples of a non-volatile digital storage include a hard disk drive, a solid state drive (SSD), a network connected storage and a storage network. Optionally storage 104 is electrically connected to processor 101, for example when storage 104 is a hard disk drive or a solid state drive. Optionally, storage 104 is connected to processor 101 via network interface 103, for example when storage 104 is a storage network or a network attached storage. Optionally, processing grid 102 is connected to storage 104.

To manage accessing memory, in some embodiments described herewithin system 100 implements the following optional method.

Reference is now made also to FIG. 2, showing a flowchart schematically representing an optional flow of operations 200, according to some embodiments. In such embodiments, in 210 memory management component 110 marks each of the plurality of memory areas 121 as pending. When system 100 implements memory caching for data, optionally data caching is disabled. Data caching may be disabled by memory management component 110. Optionally, data caching is disabled by processor 101. It should be noted that data caching refers to caching data values of a software program, and not caching of instructions or of memory address translations. Disabling data caching prevents access to outdated data in the cache. Optionally, data caching is disabled in a page-table. Optionally, data caching is disabled using a programming language directive in a source code of the software program, for example “volatile” in the C programming language. Optionally, in 205 the memory management component 110 computes a first identification of one or more data retrieval instructions directed towards the target memory 120. Optionally, the one or more data retrieval instructions comprise an instruction to read a file stored on storage 104. Optionally, the one or more data retrieval instructions comprise another instruction to receive data via network interface 103. Optionally, the one or more data retrieval instructions comprise yet another instruction to receive data from one or more software processes executed by the processor 101. Optionally, the one or more data retrieval instructions are received from processing grid 102.

Optionally, the memory management component 110 marks the plurality of memory areas as pending in response to the first identification computed in 205, optionally using plurality of pending indicators 113. Optionally, the memory management component 110 marks the plurality of memory areas as pending in a page table of system 100, optionally using for each of the plurality of memory areas 121 a pending indicator in a page table entry of the page table that is not a validity indicator of the page table entry.

Optionally, in 206 the memory management component 110 computes a second identification of the plurality of target memory areas 121, optionally according to the target memory 120 of the one or more data retrieval instructions. Optionally, the memory management component 110 computes the second identification in response to the first identification computed in 205. Computing the first identification of the one or more data retrieval instructions and additionally or alternatively computing the second identification of the plurality of memory areas 121 may be by one or more of management circuitry 112 and management processor 111. For example, management circuitry 112 may include a first testing circuitry for identifying the target memory 120 in the one or more data retrieval instructions. Additionally or alternatively, the management processor 111 may execute a first testing code for identifying the target memory 120 in the one or more data retrieval instructions. Additionally or alternatively, management circuitry 112 may include a second circuitry for computing the second identification of the plurality of memory areas 121. Additionally or alternatively, the management processor 111 may execute a second code for computing the second identification of the plurality of memory areas 121.

Optionally, marking each of the plurality of memory areas 121 as pending in 210 is in response to the second identification computed in 206.

In 220, the memory management component 110 optionally identifies that at least one first memory area of the plurality of memory areas is ready for access, for example memory area 121A and in 225 the memory management component 110 optionally removes the marking as pending for the at least one first memory area.

Reference is now made also to FIGS. 3A and 3B, showing schematic block diagrams of an exemplary sub-system 300, according to some embodiments. With reference to FIG. 3A, the plurality of pending indicators 112 comprises in this example a pending indicator 113A associated with memory area 121A, a pending indicator 113B associated with memory area 121B and a pending indicator 113C associated with memory area 121C. In 210 the memory management component 110 optionally marks as pending the pending indicator 113A associated with memory area 121A, the pending indicator 113B associated with memory area 121B and the pending indicator 113C associated with memory area 121C.

While the one or more data retrieval instructions are executing, one or more of the plurality of memory areas may become ready for access, optionally before execution of the one or more data retrieval instructions has completed. For example, the memory management component may identify that the memory area 121A is ready for access when one or more data values are stored in the memory area 121A as an outcome of executing the one or more data retrieval instructions. Optionally, the memory management component identifies that the memory area 121A is ready for access when an amount of more data values stored in the memory area 121A as an outcome of executing the one or more data retrieval instructions exceeds an identified threshold value. Optionally, the identified threshold value is an identified percentage of a maximum amount of data values that can be stored in memory area 121A. Optionally, the memory management component identifies that the memory area 121A is ready for access when the memory area 121A is completely overwritten as an outcome of executing the one or more data retrieval instructions, i.e. executing the one or more data retrieval instructions stores data in all of memory area 121A.

Reference is now made also to FIG. 3B. Optionally, in 225, the one or more memory management component 110 removes the marking that memory area is pending, for example by modifying the pending indicator 113A to indicate that memory area 121A is ready. Optionally, pending indicator 113A is a Boolean value. Optionally, pending indicator 113A is a non-Boolean value.

Reference is now made again to FIG. 2.

Optionally, in 232 the memory management component 110 accesses one or more first values in memory area 121A subject to removing in pending indication 113A the marking that memory area 121A is pending. Optionally, in 230 management component 110 identifies that memory area 121A is ready according to removing the marking that memory area 121A is pending. Optionally, management component 110 accesses the one or more first values in memory area 121A in response to identifying that memory area 121A is ready. Optionally, accessing the one or more first values includes modifying the one or more first values in memory area 121A. Optionally, the memory management component 110 accesses the one or more first values in response to one or more first memory access instructions. Optionally, the one or more first memory access instructions comprise a first memory address. Optionally, the first memory address is in a first range of memory addresses mapped to the memory area 121A. Optionally, accessing the one or more first values includes reading the one or more first values from memory area 121A.

Optionally, in 240 the memory management component 110 computes a third identification that memory area 121B is marked as pending. In 242, the memory management component 110 declines access to one or more second values in memory area 121B subject to identifying that memory area 121B is pending. Optionally, the memory management component 110 declines access to the one or more second values in response to one or more second memory access instructions. Optionally, the one or more second memory access instructions comprise a second memory address. Optionally, the second memory address is in a second range of memory addresses mapped to the memory area 121B. Optionally, the first range of memory addresses is different from the second range of memory addresses. Optionally, the first range of memory addresses and additionally or alternatively the second range of memory addresses are a range of virtual memory addresses.

It should be noted that in this example, steps 220, 225, 230, 232, 240 and 242 are executed while memory area 121B and memory 121C are still marked as pending, that is pending indicator 113B indicates that memory area 121B is pending and pending indicator 121C indicates the memory area 121C is pending. Thus, in this example, access is allowed to memory area 121A but denied to memory area 121B before execution of the one or more data retrieval instructions is completed. Optionally, memory area 121B and additionally or alternatively 121C become available before execution of the one or more data retrieval instructions is completed.

In some embodiments, system 100 executes one or more software objects, for example by processor 101. Optionally, the one or more software objects comprise a plurality of software threads, for example comprising one or more first threads and one or more second threads. For brevity, the term thread is used herewithin to mean software thread and the terms are used interchangeably.

Reference is now made also to FIG. 4, showing an optional flow of operations 400 for executing a plurality of threads, according to some embodiments. In this example, the one or more first memory access instructions are executed by the one or more first threads and the one or more second memory access instructions are executed by the one or more second threads. Optionally, the one or more second memory access instructions comprise one or more application memory addresses of the one or more software objects. Optionally after removing the marking that memory area 121A is pending, in 401 the memory management component may allow execution of the first thread. Optionally, subject to declining access to the one or more second values in memory area 121B in 242, the memory management component 110 suspends execution of the one or more second threads. Optionally, suspending execution of the one or more second threads comprises creating a mapping between the one or more application memory addresses and the one or more second threads. When the one or more second threads are executed by processor 101, suspending the one or more second threads optionally generates an exception to processor 101.

When pending indicator 113B is a non-Boolean value, suspending the one or more second threads is optionally according to a test applied to the non-Boolean value. Using a non-Boolean value allows improving efficiency of suspending and resuming the one or more second threads to reduce latency in execution of the one or more second threads. For example, when the pending indicator 113B indicates that memory area 121B will be ready in an amount of time that is less than a threshold amount of time, one or more second threads may be stored in a cache with low latency to access. Optionally, when pending indicator 113B indicates that memory area 121B will be ready in an amount of time that is greater than the threshold amount of time, one or more second threads may be stored in a storage with greater latency, for example digital storage 104. Optionally, the one or more second threads are stored in order of expected time until they can be resumed.

As noted above, before execution of the one or more data retrieval instructions completes memory area 121B may become ready for access. Optionally, upon memory area 121B becoming ready for access the memory management component 110 removes the marking as pending for memory area 121B, for example by modifying pending indicator 113B to indicate that memory area 121B is ready. In 422 the memory management component 110 resumes execution of the one or more second thread, optionally subject to removing the marking in pending indicator 113B that memory area 121B is pending. Optionally, resuming the one or more second thread is according to the mapping created in 410.

To suspend and resume the one or more second thread the memory management component 110 may implement a queue. Optionally, memory management component 110 comprise a scheduling component (not shown).

The various steps of method 200, and additionally or alternatively of method 400, may be distributed between management circuitry 112 and management processor 111, in any combination. The following figures show some possible embodiments implementing some possible combinations of implementing the steps of method 200, and additionally or alternatively of method 400, using one or more of management circuitry 112 and management processor 111.

Reference is now made also to FIG. 5, showing a sequence diagram of an optional flow of operations 500 for a memory management component comprising memory management circuitry, according to some embodiments. In such embodiments, all steps of methods 200 and 400 are executed by management circuitry 112. For example, in response to one or more data retrieval instructions 501 executed by processor 101 and directed towards target memory 120, memory management circuitry 112 executes 205, 210, 220 and 225, optionally while in 502 target memory 120 processes one or more data retrieval instructions 501. When processor 101 executes one or more first memory access instructions 510, management circuitry 112 optionally accesses one or more first values in memory area 121A in 232. Optionally, in 230 management circuitry 112 identifies that memory area 121A is ready. Optionally, management circuitry 112 accesses the one or more first values in memory area 121A in response to identifying that memory area 121A is ready. When processor 101 executes one or more second memory access instructions 520, management circuitry 112 optionally identifies in 240 that memory area 121B is pending and optionally denies in 242 access to one or more second values in memory area 121B.

Reference is now made also to FIG. 6, showing a sequence diagram of an optional flow of operations 600 for a memory management component comprising one or more hardware processors, according to some embodiments. In such embodiments, all steps of methods 200 and 400 are executed by management processor 111. For example, in response to one or more data retrieval instructions 501 executed by processor 101 and directed towards target memory 120, memory management processor 111 executes 205, 210, 220 and 225, optionally while in 502 target memory 120 processes one or more data retrieval instructions 501. When processor 101 executes one or more first memory access instructions 510, management processor 111 optionally accesses one or more first values in memory area 121A in 232. Optionally, in 230 management circuitry 112 identifies that memory area 121A is ready. Optionally, management circuitry 112 accesses the one or more first values in memory area 121A in response to identifying that memory area 121A is ready. When processor 101 executes one or more second memory access instructions 520, management processor 111 optionally identifies in 240 that memory area 121B is pending and optionally denies in 242 access to one or more second values in memory area 121B. Optionally steps 205, 210, 220, 225, 510, 230, 232, 520, 240 and 242 are executed while in 502 target memory 120 processes one or more data retrieval instructions 501.

Reference is now made also to FIG. 7, showing a sequence diagram of an optional flow of operations 700 for a memory management component comprising memory management circuitry and one or more hardware processors, according to some embodiments. In such embodiments, steps of methods 200 and 400 are executed in a first part by management processor 111 and in a second part by management circuitry 112. For example, in response to one or more data retrieval instructions 501 executed by processor 101 and directed towards target memory 120, memory management processor 111 executes 205 and 210, whereas steps 220 and 225 are executed in this example by management circuitry 112. When processor 101 executes one or more first memory access instructions 510, management processor 111 optionally sends the one or more first memory instructions to management circuitry 112 in 710. Optionally, in 230 management processor 111 identifies that memory area 121A is ready. Optionally, management processor sends the one or more first memory instructions in response to identifying that memory area 121A is ready. Optionally, in 232 management circuitry 112 accesses one or more first values in memory area 121A. When processor 101 executes one or more second memory access instructions 520, management processor 111 optionally identifies in 240 that memory area 121B is pending and optionally denies in 242 access to one or more second values in memory area 121B. Optionally steps 205, 210, 220, 225, 510, 710, 230, 232, 520, 240 and 242 are executed while in 502 target memory 120 processes one or more data retrieval instructions 501.

Reference is now made also to FIG. 8, showing a sequence diagram of another optional flow of operations 800 for a memory management component comprising memory management circuitry and one or more hardware processors, according to some embodiments. In such embodiments, steps of methods 200 and 400 are executed in another first part by management processor 111 and in another second part by management circuitry 112. For example, in response to one or more data retrieval instructions 501 executed by processor 101 and directed towards target memory 120, memory management circuitry 112 executes 205 and 206, and in 810 memory management circuitry 112 sends management processor 111 a request to mark the plurality of memory areas 121 as pending. Optionally, management circuitry 111 executes 210, whereas step 220 is executed in this example by management circuitry 112. In 820, optionally in response to management circuitry 112 executing 220, management circuitry 112 optionally sends in 820 to management processor 111 a request to remove the marking as pending for memory area 121A. In this example, 225 is executed by management processor 111. When processor 101 executes one or more first memory access instructions 510, management circuitry 112 optionally accesses one or more first values in memory area 121A in 230. Optionally, in 230 management circuitry 112 identifies that memory area 121A is ready. Optionally, management circuitry 112 accesses the one or more first values in memory area 121A in response to identifying that memory area 121A is ready. When processor 101 executes one or more second memory access instructions 520, management circuitry 112 optionally identifies in 240 that memory area 121B is pending and optionally denies in 242 access to one or more second values in memory area 121B. Optionally steps 205, 206, 810, 210, 820, 220, 225, 510, 230, 232, 520, 240 and 242 are executed while in 502 target memory 120 processes one or more data retrieval instructions 501.

In some embodiments, memory management component 110 is implemented in one or more semiconductor components. To produce memory management component 110, some embodiments use the following optional method.

Reference is now made also to FIG. 9, showing a flowchart schematically representing an optional flow of operations 900 for producing a memory management component, according to some embodiments. In such embodiments, in 910 a substrate is formed, in in 210 a plurality of logical elements are deposited on the substrate. Optionally, in 920, a plurality of interconnects are incorporated to establish one or more communication pathways among the plurality of logical elements. Optionally, the one or more communication pathways are established such that the memory management component is configured to implement at least part of method 200. For example, the one or more communication pathways may be established such that the memory management component is configured to mark each of a plurality of memory areas as pending in response to identifying one or more retrieval instructions directed towards a target memory, where the target memory comprises the plurality of memory areas and where each memory area is associated with a range of memory addresses that is mapped thereto. Optionally, the one or more communication pathways may be established such that the memory management component is configured to, while one or more of the plurality of memory areas is marked as pending: remove the marking as pending for at least one first memory area of the plurality of memory areas upon the at least one first memory area being ready for access; and access at least one first value in the at least one first memory area in response to at least one first memory access instruction, subject to the removal of the marking as pending of the at least one first memory area.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant memory management components will be developed and the scope of the term “memory management component” is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment may include a plurality of “optional” features unless such features conflict.

Throughout this application, various embodiments may be presented in a range format. It should be understood that the description in range format is merely for convenience and brevity and should not be construed as an inflexible limitation on the scope of embodiments. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of embodiments, which are, for clarity, described in the context of separate embodiments, may also be provided in combination in a single embodiment. Conversely, various features of embodiments, which are, for brevity, described in the context of a single embodiment, may also be provided separately or in any suitable subcombination or as suitable in any other described embodiment. Certain features described in the context of various embodiments are not to be considered essential features of those embodiments, unless the embodiment is inoperative without those elements.

Although embodiments have been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A method for producing a memory management component, comprising:
forming a substrate;
depositing a plurality of logical elements on the substrate; and
incorporating a plurality of interconnects to establish at least one communication pathway among the plurality of logical elements such that the memory management component is configured to:
mark each of a plurality of memory areas as pending in response to identifying at least one data retrieval instruction directed towards a target memory comprising the plurality of memory areas, each memory area associated with a range of memory addresses that is mapped thereto; and
while at least one of the plurality of memory areas is marked as pending:
remove the marking as pending for at least one first memory area of the plurality of memory areas upon the at least one first memory area being ready for access; and
access at least one first value in the at least one first memory area in response to at least one first memory access instruction, subject to the removal of the marking as pending of the at least one first memory area.

2. A system for accessing memory, comprising at least one memory management component configured to:
mark each of a plurality of memory areas as pending in response to identifying at least one data retrieval instruction directed towards a target memory comprising the plurality of memory areas, each memory area associated with a range of memory addresses that is mapped thereto; and
while at least one of the plurality of memory areas is marked as pending:
remove the marking as pending for at least one first memory area of the plurality of memory areas upon the at least one first memory area being ready for access; and
access at least one first value in the at least one first memory area in response to at least one first memory access instruction, subject to the removal of the marking as pending of the at least one first memory area.

3. The system of claim 2, wherein the at least one memory management component comprises at least one memory management circuitry configured to execute one or more of: mark each of the plurality of memory areas as pending, remove the mark as pending, and access the at least one first value.

4. The system of claim 2, wherein the at least one memory management component comprises at least one hardware processor configured to execute a code to execute one or more of:
mark each of the plurality of memory areas as pending, remove the mark as pending, and access the at least one first value.

5. The system of claim 2, wherein the at least one memory management component comprises for each of the plurality of memory areas a pending indicator associated therewith, for marking whether the memory area associated with the pending indicator is pending.

6. The system of claim 2, wherein the at least one memory management component is further configured to:
compute a first identification of the at least one data retrieval instruction; and
in response to the first identification of the at least one data retrieval instruction, compute a second identification of the plurality of memory areas to mark as pending.

7. The system of claim 2, wherein the at least one memory management component is further configured to:
identify that the at least one first memory area is ready for access; and
remove the marking as pending for the at least one first memory area.

8. The system of claim 2, wherein the at least one memory management component is configured to identify that the at least one first memory area is ready for access when one or more data values are stored in the at least one first memory area as an outcome of executing the at one data retrieval instruction.

9. The system of claim 2, further comprising:
at least one hardware processor configured to execute at least one software object; and
a page table mapping a plurality of application memory addresses to the plurality of memory areas, where an application memory address is a memory address of the at least one software object;
wherein for each memory area of the plurality of memory areas, the range of memory addresses that is mapped to the memory area is a range of application memory addresses of the at least one software object;
wherein the page table comprises a plurality of page table entries, each for mapping at least one range of application memory addresses to at least one of the plurality of memory areas;
wherein each of the plurality of page table entries comprises a validity indicator, indicative of whether the page table entry contains a valid mapping; and
wherein marking a memory area is pending is by using a pending indicator in the page table that is not a validity indicator.

10. The system of claim 2, further comprising:
at least one hardware processor configured to execute at least one software object; and
a page table mapping a plurality of application memory addresses to the plurality of memory areas, where an application memory address is a memory address of the at least one software object;
wherein the page table comprises at least one table entry, each mapping a first amount of application memory addresses of the plurality of application memory addresses;
wherein for at least one memory area of the plurality of memory areas, the range of memory addresses that is mapped to the memory area is a range of application memory addresses of the at least one software object having a second amount of application memory addresses; and
wherein the first amount of application memory addresses is different from the second amount of application memory addresses.

11. The system of claim 2, wherein the at least one memory management component is further configured to:
further while the at least one of the plurality of memory areas is marked as pending, decline to access at least one second value in at least one second memory area of the plurality of memory areas, where the at least one second memory area is marked as pending, in response to at least one second memory access instruction.

12. The system of claim 11, wherein the at least one memory management component is further configured to compute a third identification that the at least one second memory area is marked as pending.

13. The system of claim 11, wherein the at least one first memory access instruction comprises a first memory address in a first range of memory addresses mapped to the at least one first memory area; and
wherein the at least one second memory access instruction comprises a second memory address in a second range of memory addresses mapped to the at least one second memory area.

14. The system of claim 11, further comprising at least one hardware processor configured to execute at least one software object, comprising a plurality of threads;
wherein the at least one first memory access instruction is executed by at least one first thread of the plurality of threads;
wherein the at least one second memory access instruction is executed by at least one second thread of the plurality of threads; and
wherein the at least one memory management component is further configured to:
allow execution of the at least one first thread; and
subject to declining to access the at least one second value in the at least memory area that is marked as pending, suspend execution of the at least one second thread.

15. The system of claim 14, wherein the at least one memory management component is further configured to:
remove the marking as pending for the at least one second memory area upon the at least one second memory area being ready for access; and
resume execution of the at least one second thread subject to removing the marking as pending for the at least one second memory area;
wherein the at least one second memory access instruction comprises at least one application memory address of the at least one software object;
wherein suspending execution of the at least one second thread comprises creating a mapping between the at least one application memory address and the at least one second thread; and
wherein the at least one memory management component is further configured to: subject to removing the marking as pending for the at least one second memory area, resume the at least one second thread according to the mapping.

16. The system of claim 14, further comprising at least one reconfigurable processing grid connected to the at least one hardware processor;
wherein the at least one reconfigurable processing grid is configured to execute at least one of the at least one first thread and the at least one second thread.

17. The system of claim 16, wherein the at least one reconfigurable processing grid comprises one or more of the at least one memory management component.

18. The system of claim 2, further comprising at least one hardware processor; and
wherein the at least one data retrieval instruction comprises at least one of:
an instruction to receive data via at least one digital communication network interface connected to the at least one hardware processor;
an instruction to receive data from at least one software process executed by the at least one hardware processor; and
an instruction to read from a file stored on at least one non-volatile digital storage.

19. The system of claim 2, wherein marking a memory area as pending is by using a non-Boolean value.

20. A method of accessing memory, comprising:
marking each of a plurality of memory areas as pending in response to identifying at least one data retrieval instruction directed towards a target memory comprising the plurality of memory areas, each memory area associated with a range of memory addresses that is mapped thereto; and
while at least one of the plurality of memory areas is marked as pending:
removing the marking as pending for at least one first memory area of the plurality of memory areas upon the at least one first memory area being ready for access; and
accessing at least one first value in the at least one first memory area in response to at least one first memory access instruction, subject to the removal of the marking as pending of the at least one first memory area.
